(19) United States
(12) Patent Application Publication
(10) Pub. No.: US 2005/0234990 A1
(43) Pub. Date: Oct. 20, 2005

(54) System and method for tracking documents

(76) Inventors: Christopher Nigel Alexander Brighouse, Bothwell (GB); Graham Cruicksanks, Glasgow (GB)

Correspondence Address: TESTA, HURWITZ & THIBEAULT, LLP, HIGH STREET TOWER, 125 HIGH STREET, BOSTON, MA, 02110, US

(21) Appl. No.: 10/827,102

(22) Filed: Apr. 18, 2004

(51) Int. Cl. G06F 17/30

(52) U.S. Cl. 707/104.1

(57) ABSTRACT

Systems and methods of cataloging substantially all interactions with substantially all versions of a document on a computer network comprising are disclosed. In one embodiment, the system may perform the following steps: determining that the document has entered the network; creating a history for the document, the history comprising references to each copy of the document on the network and each version of the document on the network; and updating the history each time a copy of the document or a version of the document is interacted with.

### FIELD OF THE INVENTION

The present invention relates to tracking the usage, distribution and control of electronic files within local area network and across the Internet.

### BACKGROUND OF THE INVENTION

In the field of Document Management, even on a controlled corporate network, the distribution of files across computers is disorderly by nature. Control and management of corporate files (or “documents”) is a typical sales message from most Content (or document) Management (CM) vendors. A CM system can only be successful, however, if there is a rigid working practice in place ensuring that all users interact only with the CM system when working with files. This is rarely the case, however, as multiple systems are typically available for different business functions and all of these systems may have the ability to interact with files. For instance, e-mail systems may allow users to send a file, such as a document, to a location that is external to the network. This allows, for example, a document to be sent to an external location, edited, and returned to the system by another e-mail in its edited form. The edited version, however, may not be saved into the CM system thus resulting in different versions of the document being resident in the computer network.

One way to address this issue has been the development of EAI (Enterprise Application Integration) technologies, which can be used to connect disparate systems together so that information in each remains synchronized. This has some benefits, but is extremely costly to design, implement and maintain in an environment of constantly changing systems and business practices.

There are a number of paper document tracking systems on the market, such as RFID from Texas Instruments, which uses tagged labels added to documents and a central database to maintain document locations. These “paper-tracking” systems are highly effective in many areas and are used extensively by major parcel companies. The problem with an analogous solution for electronic files is that it would require the modification of the files being tracked.

U.S. patent application No. US20002178436 to IBM teaches of a method, apparatus, and computer implemented instructions for tracking relationships between programs and data in a data processing system. A file access request is received from a program, wherein the request is received at an operating system level. An association is stored between the file and the program. This system tracks relationships between an application and its files but does not track relationships between files created by desktop applications.

Patent Application Number WO0023867 to Evolutionary Vision Technology teaches of a method that detects states that are activated by a user of a computer unit and includes: checking a set of values and/or characters in a memory area of the computer unit wherein each set of values correspond to a state activated by the user; and capturing each set of values to determine each state activated by the user. Each state corresponds to a Windows frame state and, alternatively, to a dialog box state. This system tracks the use of the main computer functions and internal memory and records it centrally. It does not, however, capture the relationships between files as they are created and manipulated by the user through desktop applications.

One of the major shortcomings of the above and other prior art systems is that they may fail to keep track of every version or every copy of a document in a computer network. For instance, suppose a user e-mails a document outside of the computer network and then receives an edited version of the document from the entity to which the document was sent. In the computer network there may exist several different copies of the document as well as several different versions of the document. For instance, the local drive on the user's computer could have a back-up copy of the sent document and a copy of the document in the “outbox” of the e-mail system, as well as the edited version in the in-box. The CM system may only have a record of the version of the document that was originally sent out via e-mail and, will not know of the revisions if and until the revised document is checked back into the system. Thus, another user may attempt to access the document via the CM system and not know that it has been revised, thus resulting in edits being made to a version of the document that is not the most current.

What is needed therefore, is a system that may keep track of substantially all copies and substantially all versions of every document within a computer network, regardless of whether the document is saved in a CM system. As used herein, the term “document” shall refer to any type of electronic file that may be saved in a computer network.

### SUMMARY OF THE INVENTION

In one embodiment, the invention is directed to a method of cataloging substantially all interactions with substantially all versions of a document on a computer network. In one embodiment, this method includes: determining that the document has entered the network; creating a history for the document which includes references to each copy of the document on the network and each version of the document on the network; and updating the history each time a copy of the document or a version of the document is interacted with.

In another embodiment, the invention is directed to a method of tracking documents on a computer network. The method of this embodiment may include receiving an indication that either a copy of a document or a version of the document has been accessed; determining if a history for the document exists; and updating the history assigned to the document.

In yet another embodiment, the invention is directed to a system for tracking documents on a computer network. The system includes a pre-processing module that receives a signal indicating that a document in the computer network has been accessed by a user. The system of this embodiment also includes a processing engine that analyzes the signal to determine if the document is the same as a pre-existing document having a history associated therewith. The system of this embodiment also includes a notification engine that causes the user of the document to be notified if the document being accessed has pre-defined characteristics.

### BRIEF DESCRIPTION OF THE FIGURES

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a high level block diagram of one embodiment of the present invention;

FIG. 2 is a more detailed block diagram of the system shown in FIG. 1;

FIG. 3 is a high level flow chart of one process that is performed by a plug-in associated with an event creator of FIG. 1;

FIG. 4A is a high level flow chart of one process that is performed in an event receiver according to one embodiment of the present invention;

FIG. 4B is a high level flow chart of another process that is performed in the event receiver according to one embodiment of the invention;

FIG. 5 is a high level block diagram of an event recorder according to one embodiment of the present invention;

FIG. 6 is a high level flow chart of one process that is performed in the preprocessor according to one embodiment of the invention;

FIG. 7 is a flow chart showing an example process that is performed in the event processor according to one embodiment of the invention;

FIG. 8 is a high level flow chart showing one process that is performed in the alert engine according to one embodiment of the invention;

FIG. 9 shows an optional portion of an embodiment of the invention that includes a report generator coupled to the database.

### DETAILED DESCRIPTION

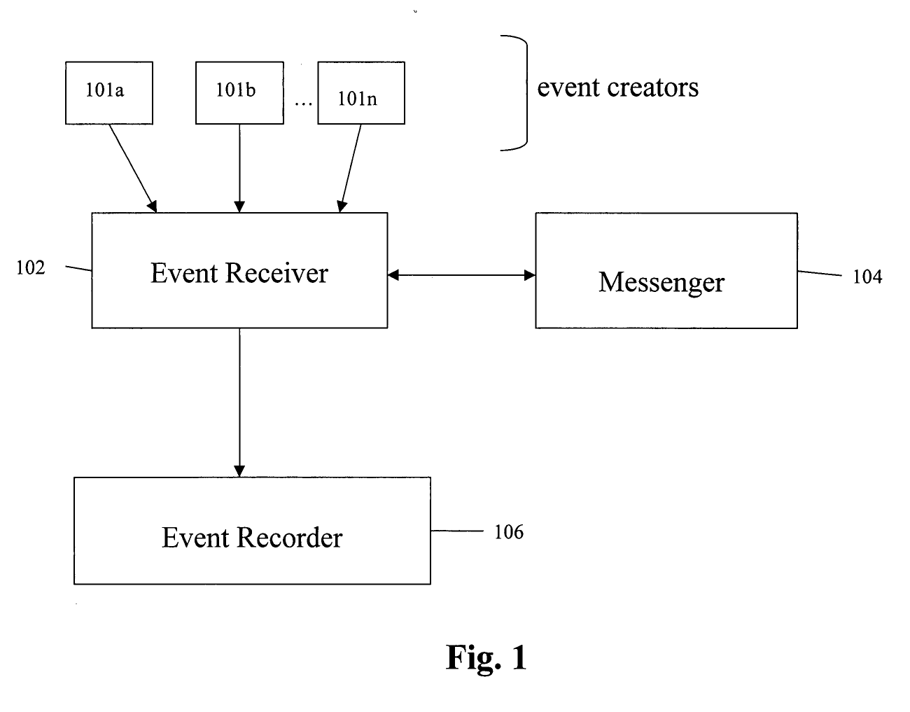

FIG. 1 is a high level block diagram of a system according to one embodiment of the present invention. The system includes event creators 101a, 101b . . . 101n. These event creators may be programs or other applications running on any computer included in a computer network. Generally, event creators 101a . . . 101n create events whenever a document in the computer network is created, altered, accessed, copied, saved, opened, sent or received via e-mail, deleted, renamed, copied, or otherwise manipulated or interacted with by a user. Each of these types of actions shall be referred to generally herein as “interactions” as that term is used with respect to a document. Examples of event creators may include, but are not limited to, programs that control word processing, email, file system monitors or other applications that allow a user to create, modify, or transmit a document from one computer to another.

In some embodiments, every time a user interacts with a document, the event creator that was employed during the interaction sends a message indicating that the document has been interacted with to the event receiver 102. In some embodiments, the event creators 101a-101n send messages that include the type of interaction with the document that was conducted to the event receiver 102.

In some embodiments, the event receiver 102 may, for instance, be a program such as a Windows Service called .NET. Of course other programs that may be resident on an individual computer and that can record interactions with documents, may also be used. For instance, the event receiver 102 may be a JAVA applet, Unix kernel or the like so long as it is programmed to receive messages (or other indications) that represent that an event creator 102a . . . 102n has interacted with a document in a computer system.

The event receiver may also be in contact with a messenger program 104. The messenger program 104 may provide, for instance, pop-up windows giving messages to the user such as, for instance, that the version of the document being interacted is not the most current version.

The event receiver 102 is coupled to an event recorder 106. The event recorder 106 may, in some embodiments, store a history of the interactions with a particular document in the computer network. From time to time herein the term “document chronicle” shall be used in place of “history.” The event recorder 106 may be located externally to a user's computer. For instance, the event recorder 106 may be located on an external server that may be accessed by computers attached to a particular computer network. In other embodiments, the event recorder 106 may be remotely located and accessed via the internet. The event recorder 106 is described further below.

It should be understood that, in some instances, the event receiver 102 may receive and store events even when a particular computer is not coupled to a computer network. When the computer is subsequently attached to a computer network, the contents of the event receiver may then be sent to the event recorder 106. To this end, the event receiver 102 may, in some embodiments, compile received messages into an output queue (not shown), the contents of which may later be transferred to the event recorder 106. In some embodiments, when a document is created by any program, a unique identifier may be created by system for the document. In such embodiments, the event creators may include the an algorithm or other means to create the unique identifier for the document that may also identify a version of the document. In other embodiments, a unique identifier for the document/version may be created for the document by the event recorder.

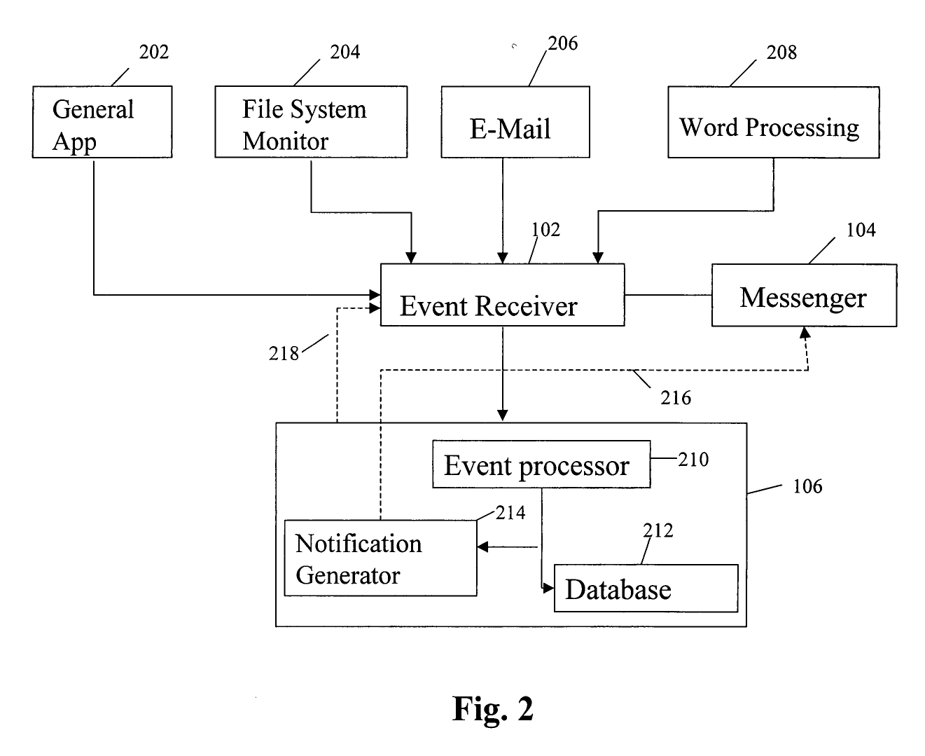

FIG. 2 is a more detailed depiction of the system shown in FIG. 1. The system shown in FIG. 2 includes a general application 202, a file system monitor 204, an e-mail system 206, and a word processing system 208. These systems, in the parlance of FIG. 1, may collectively be called event creators. Of course, other types of event creators may also be included in the system. Again, these event creators notify the event receiver 102 whenever a document is interacted with by a user or the user's computer.

The event recorder 106 includes, in some embodiments, an event processor 210, a database 212, and a notification generator 214. The event processor 210 may, in some embodiments, determine whether a document that has been interacted with is in the system currently, and whether or not that document already has a history associated with it. Of course, as described further below, the event processor 210 may perform other. tasks as well.

The event processor may be coupled to both a database 212, and a notification generator 214. The database 212 stores a history (document chronicle) that, in some embodiments, includes every interaction with every document in the computer network. This database may be located in any location and may even be remote from the computer network. The database 212 may be a relational database such as an ISQL provided by Oracle.

The notification generator 214 analyzes the output of the event processor and determines, among other things, whether the document that is being interacted with is the most current document that is on the computer network. The notification generator may, in some instances, be coupled to the messenger 104 either directly, as indicated by dashed line 216, or through the event receiver 102, as indicated by dashed line 218.

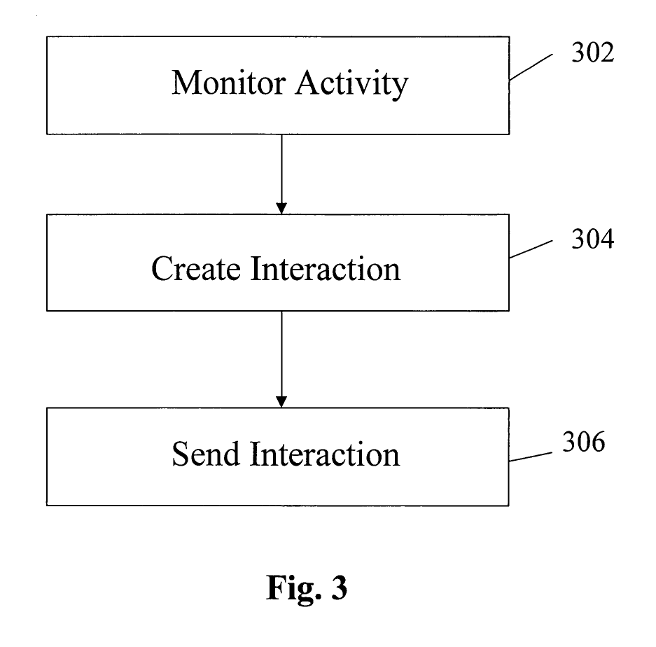

FIG. 3 shows an example of an optional “add-in” program that may be associated with each event creator in the system. That is, each event creator in the system may have extra portion that helps ensure that each interaction with a document is sent to the event receiver 102 (FIG. 1). In some instances, one add-in program may monitor all the activity of all event creators. In other instances, each event creator may have an individual add-in program associated with it. Of course, other permutations of the relations between the add-in programs and events creators are within the scope of the present invention and will be readily apparent to one of skill in the art.

Regardless of the configuration or particular association of the add-in program to an event creator, the add-in program monitors the activity of the event creator in step 302. The monitoring may preferably be done in such manner that is transparent to the user. The monitoring performed step 302 may include, for example, monitoring all function calls from the event creator to the operating system on an individual user's computer or vice-versa. For instance, if the add-in program is monitoring an e-mail program, the monitoring of step 302 may monitor each time a message is received by or sent from the e-mail system. This message may include an attached or embedded document and the add-in may be configured to determine if the message includes such an attached or embedded document. In another example, if the add-in program is monitoring a word processing system, the monitoring of step 302 may monitor each time a document is opened, closed, saved, or otherwise interacted with by a user. Again this may be accomplished by monitoring function calls between the event creator and the operating system. Of course, other methods of monitoring may be implemented, are within the scope of the present invention, and will be readily apparent to one of skill in the art. For instance, each event create may include an application programming interface (API) which is a specific method prescribed by a computer operating system or by an application program by which a programmer writing an application program can make requests of the operating system or another application. The monitoring is done through the API.

As the activity is being monitored in step 302, notifications of interactions with the document may be created at step 304, if the interaction is of interest to the system of the present invention. For instance, a notification of interaction may be created at step 304 if a document is saved, opened, closed, modified, sent to another computer (either inside or outside of the network) or otherwise interacted with. Of course, in some embodiments, all interactions need not result in a notification. For instance, a notification may not need to be created every time a user inputs a character in the document but, rather, only when the document is saved. The determination of which interactions should cause a notification is within the knowledge of one of skill in the art when combined with the teachings herein. Of course, all interactions could be monitored and a notification created and subsequently sorted by another portion of the system.

Then, at step 306, the interaction is sent to event receiver 102 (FIG. 1). The process shown in FIG. 3 may, in some embodiments, constantly run or, in other embodiments, may run periodically.

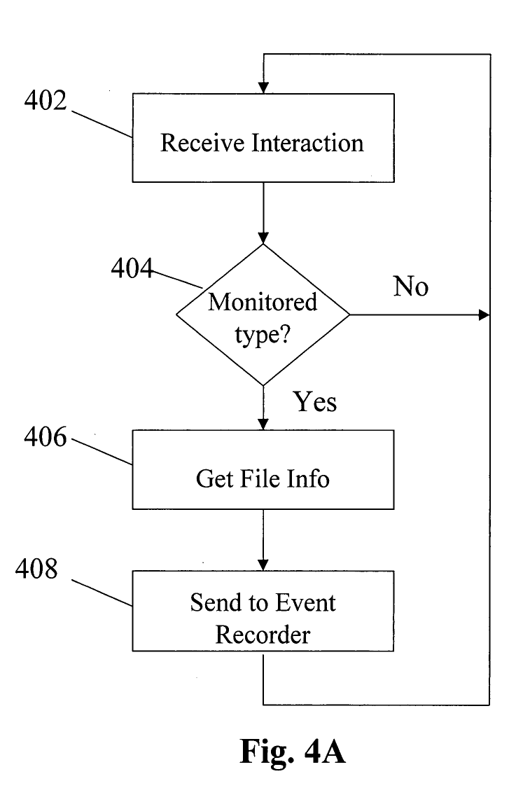

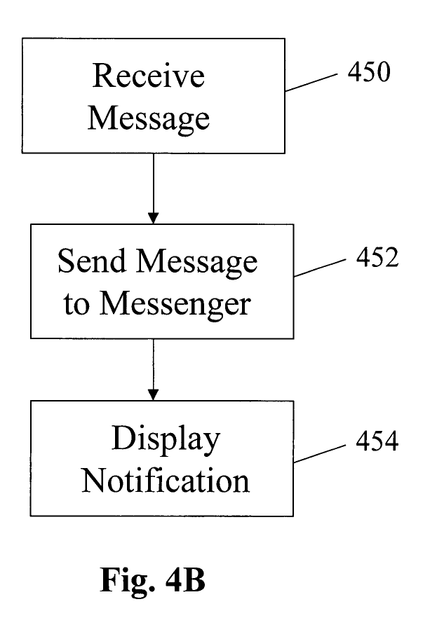

FIG. 4A is a high level flow chart of one of the processes that may occur in the event receiver 102 (FIG. 1). Of course, the event receiver could be configured in many different manners as will be readily recognizable by one of skill in the art. In a preferred embodiment the event receiver is implemented in software and should be able to determine every time a document is interacted with by any of the event receivers 101. In such embodiments, the event receiver may be programmed in java, Windows .NET programs or the like.

The process begins at step 402 when an event interaction notification is received. The notification may be received from any of the event creators. Of course, the event receiver may include an input queue to store notifications until they can be processed but such a queue may not be required.

Regardless of where the notification is received from, in some embodiments, the process then determines, at step 404, if the interaction is of the type that is being monitored. As discussed above, however, the system may be configured such that only monitored interaction types are sent to the event receiver. In such cases, step 404 may be omitted.

In cases where step 404 is not omitted, if the notification is not of the type being monitored, the process returns to step 402 where the next interaction is received. If the notification is, however, of the type being monitored, the process progresses to step 406 where information about the file is gathered. The information gathered in various embodiments includes, but is not limited to, the file name, a unique identifier associated with the file, the file size, the creator of the file, the user that interacted with the file, and, in some instances, the file itself. Next, at step 408, the information that has been gathered is sent to the event recorder 106 (FIG. 1).

Referring again to FIG. 1, other processes may also be carried out in the event receiver 102. For instance, and as discussed above, the event receiver may also handle interactions with the messenger 104. In such cases, the event receiver may also perform the steps shown in FIG. 4B.

FIG. 4B is a high level flow chart of how event messaging handled by the event receiver. The process begins when a message is received at step 450. As discussed above, the message may be received, in some embodiments, from the event recorder 106 (FIG. 1). After the message has been received, it may be sent, at step 452 to the messenger 104 for display to the user. Of course, to handle multiple messages, the event receiver may have an message queue that stores messages until they can be sent to the messenger. The types of messages that may be sent to the messenger are unlimited and may include, for example, indications that the user is not working on the most current version of a document or that the document is currently being interacted with by another user. This process, however, may be conducted in other portions of the system of the present invention, such as in the messenger 104 or any other portion shown own not shown herein. Finally, at step 454, the notification is displayed.

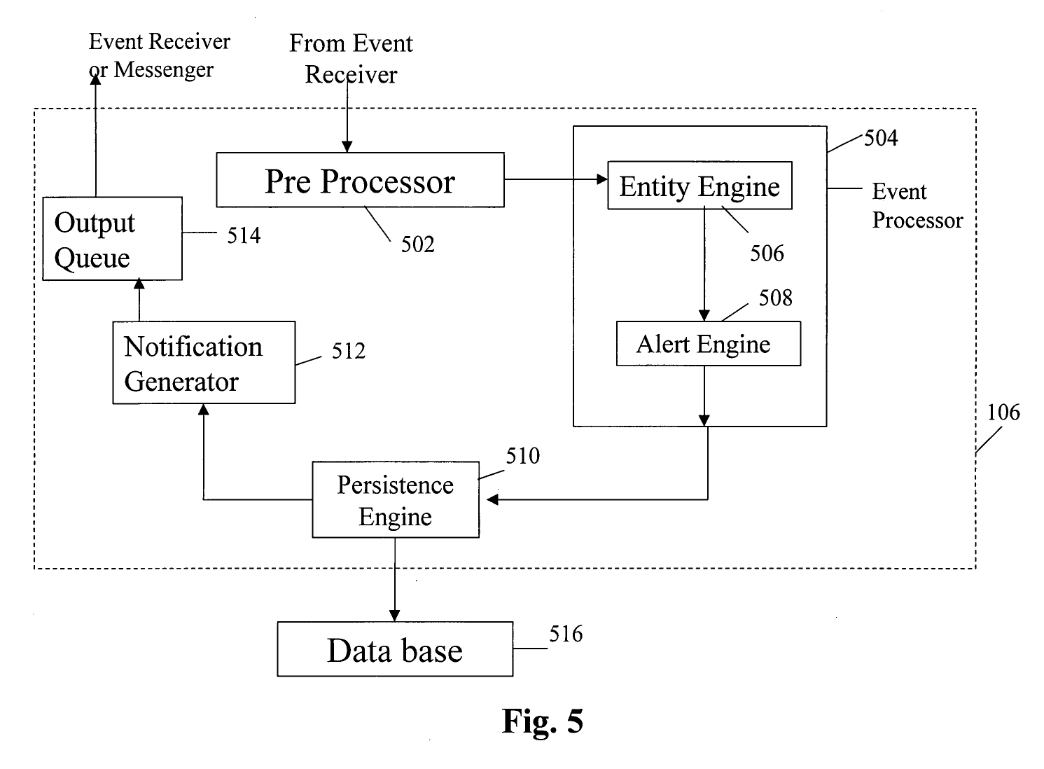

FIG. 5 is a more detailed depiction of an embodiment of event recorder 106 shown in FIG. 1. As shown, the database 516 is external to the event recorder 106. However, as one of ordinary skill in the art readily realizes, this database may be within the event recorder as well. That is, the location of the database is optional as long as it is in some manner coupled to the event recorder 106.

In this embodiment the event recorder 106 includes a preprocessor 502, an event processor 504, a persistence engine 510, a notification generator 512, and an output queue 514. Of course, these different components could be combined with other components as one of ordinary skill in the art would readily realize.

In more detail, the preprocessor 502 handles information received from the event receiver 102. In some embodiments, the preprocessor may ensure that the data received is in the correct format for the event processor to operate on. The preprocessor then passes the correctly formatted information to the event processor 504. The event processor 504 includes an entity engine 506 and an alert engine 508. The entity engine 506, generally, determines whether the document that has been interacted with is in the system or not. If the document is in the system, then the interaction is added to a history associated with the document which may be stored, for example, in the database 516.

The alert engine 508, generally, determines whether the interaction being performed on the document is permissible. In the event that such interaction is not permissible an alert or an alarm may be generated for transference to the messenger via notification generator 512. Both the updates and the alerts created by, respectively, the entity engine 506 and the alert engine 508 may then be passed through the persistence engine 512 for update to the database 516. The results of processing by the alert engine 508 may then be processed by the notification generator 512 to generate a notification that may be displayed by the messenger. In some embodiments, the notifications may be placed in an optional output queue 514.

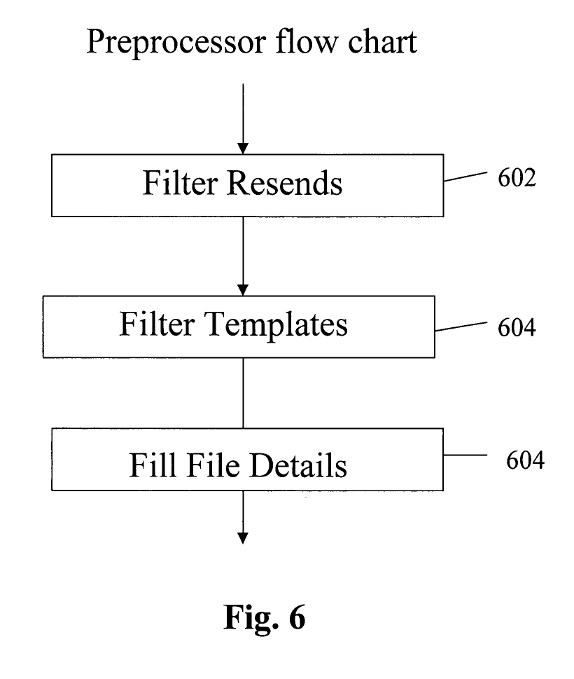

FIG. 6 is a high level flow chart of the process conducted by the preprocessor 502. The preprocessor may first, in some embodiments, filter resends of interaction notifications that have previously been sent in step 602. This process, may help to avoid the same interaction on a particular document being recorded multiple times due to the same interaction being sent multiple times. For instance, when a document is attached to an e-mail and clicked on to be opened this may generate an “open” interaction from both the e-mail program and the word processing program and both interactions may be sent to the event recorder. Filtering the resends may be accomplished, for example, by only allowing one “open” interaction for a particular document to be recorded from one users computer every couple of seconds. In some instances, a resend may occur when there is a communication error and the user does not receive a confirmation that the server received and processed the interaction.

Next, at step 504, system checks the document against a list of known templates so that interactions on templates are not recorded. This enables the server to make sure that document versions are not linked to a root document that is a template like the default blank word processing templates that come with standard word processing programs. The templates can be added to include company selected templates.

Next, at step 506, the “Fill File Details Filter” fills missing interaction details for interaction types. For example, a copy and a overwrite of a file uses this filter to copy the document properties from the source file location to the destination file location in the interaction to the client does not have to send to and thus saving network bandwidth.

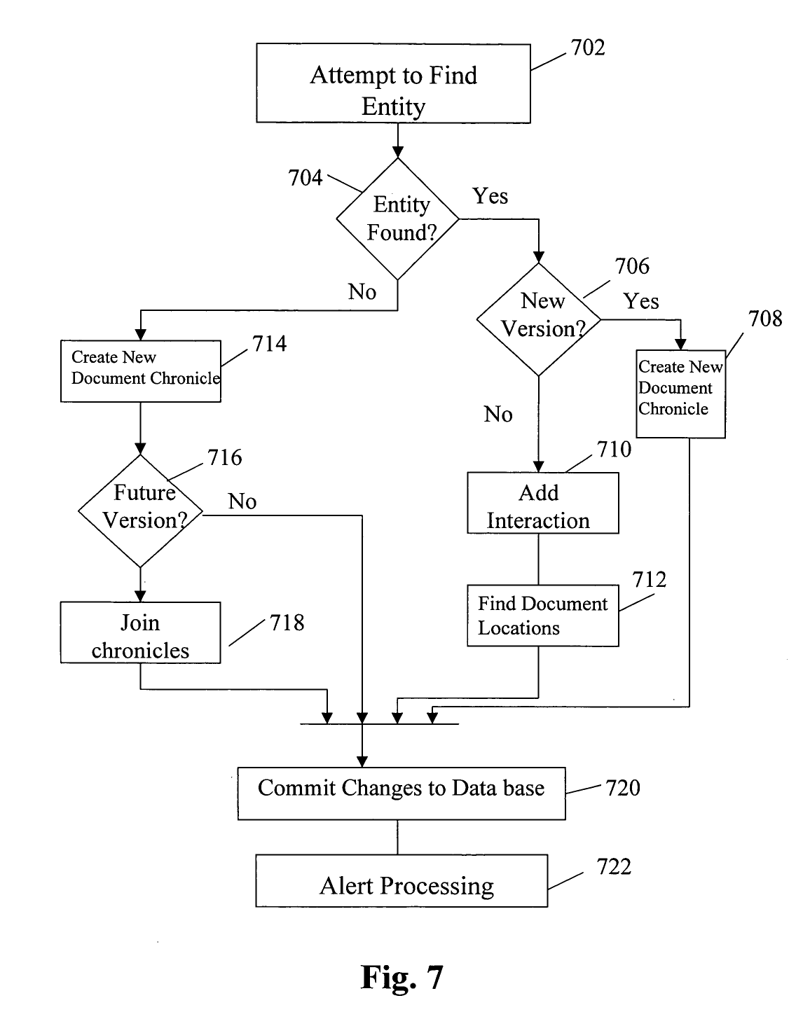

FIG. 7 is a process flow diagram that details the operation of one embodiment of the event processor 210 (FIG. 2). The process of this embodiment takes place after the operations of the preprocessor described above are completed. The process begins at step 702 when the event processor attempts to determine if the document is same document that is already in the system, is a different version of a document already in the system, or is a new document entirely.

One way in which the system may determine if a document is the same as one already in the system is to examine if and how the document was saved in the CM system. Another way is to perform hash algorithm, such as the MD5 hash algorithm, to compare the entire document with documents already in the computer system. Another way in which this may be accomplished is to compare creation dates and times of documents in the system to determine if this document was created at the same another document in the system. It yet other embodiments, a unique identifier associated with the document may be utilized to determine if the document is already in the system. In other embodiments, it is possible to identify a document by its current location. i.e. C:\test.doc is in the system as that location. If the system receives a delete interaction of that location it can be assumed that is was that document.

If the document on which an interaction occurred is a document that is new to the system, decision block 704 transfers control of the process to step 714 where a new document chronicle is created for that new document. The document chronicle is a history of interactions of the document conducted by any user in the computer system. This chronicle is ultimately stored in the database and may be updated each time the document is interacted with or only when certain interactions occur. As discussed below, updates may include adding the interaction to the document chronicle as well as recording all locations of the document in the system.

In some embodiments, the process may also include a step 716 where it is determined whether “future versions” of the document exist. This step allows for the event processor to link out sequence interactions with a particular document. This may happen, for example, when a lap-top computer user creates a document while disconnected from the computer network and then sends that new document to a user that is connected to the computer network. This new document gets a new document chronicle when it is received by the user connected to the computer system (as described above). When the lap-top computer is then reconnected to the computer system, the contents of the event receiver may then be pushed to the event recorder. These contents will appear to represent the creation of a new document that needs to be entered into the system. However, upon further processing it may be discovered that the interactions actually apply to the document chronicle that was created when the document was received by the user that was connected to the system. This may be determined as follows. When a chronicle is created for a document then there is a root document. This is the very first version. When a new version of the document is saved a child node is created. If the child node matches a root node of an existing chronicle then that matched root node and its existing children should be substituted for the child. The matched chronicle can then be deleted.

If this is not true, the new chronicle is stored in the database at step 720. If this is true, then at step 718, the two chronicles are joined to form one chronicle. After the chronicles are joined, the updated chronicle may be stored in the database at step 720.

Referring now back to step 704, if the document already exists then it is determined, at step 706, if this document is a different version of a pre-existing document. If so, at step 708 a new document chronicle may be created for the document. For such embodiments, the new version may be associated with the prior version and represented as, for example, a branch off the original document chronicle. This may be useful for determining if a user is accessing a document that is not the most current version of the document.

If the document exist in the computer system and is not a new version then the interaction is added to the document chronicle for the document in step 710. Additionally, in some embodiments, the location of all of all copies of the document may be determined in step 712. This may be accomplished, for example, by examining the document chronicle for all locations where the document was saved, received, or otherwise interacted with.

Regardless of the status of the document (i.e., new, new version, or existing) after the document has been analyzed, the recent interaction is committed to the database in step 720. After step 720, the alert processing step 722 is performed and is described in greater detail below.

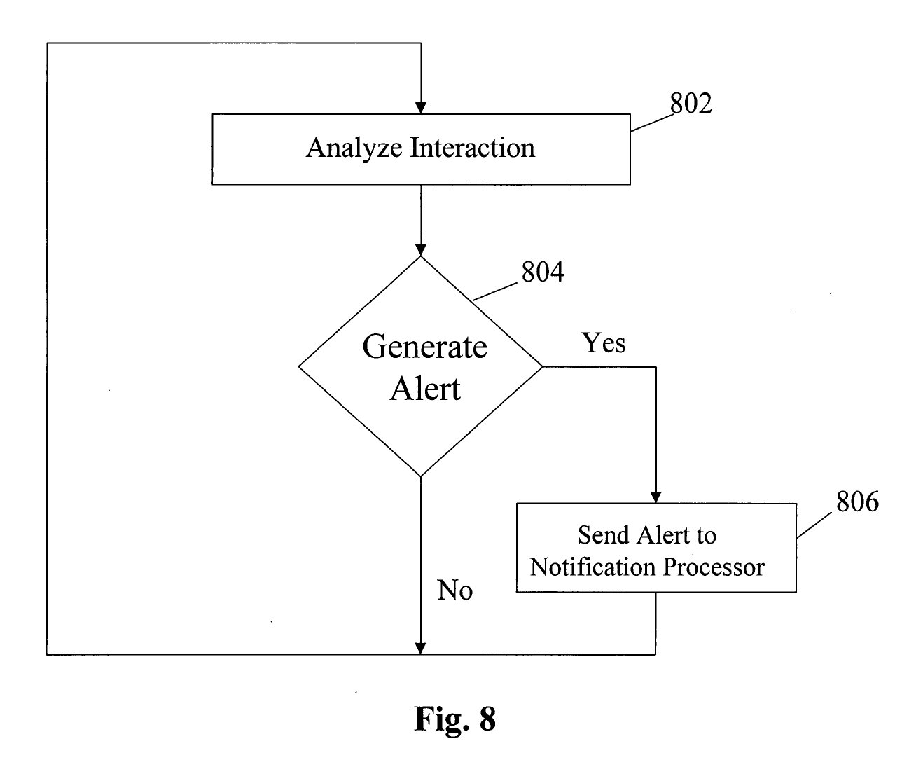

FIG. 8 is a more detailed flow diagram of one embodiment of a process that may be performed in the alert processing step 722 (FIG. 7). The process shown in this embodiment begins at step 802 where the interaction is analyzed. In some embodiments, this step may, however, be omitted because the interaction may already be known from the processes performed and described with respect to FIG. 7. Regardless, at step 804, it is determined whether an alert should be generated. Alerts may be generated for several reasons and may, in some instances, depend on certain rules established by the administrator of the computer system (or others). These rules may include, for example, notifying a user that the document being accessed is not the most current version or that the user is attempting to perform an action that is not allowed or dangerous such as deleting a document from the system. If an alert is to be generated, the alert is sent to the notification processor (discussed above) at step 806.

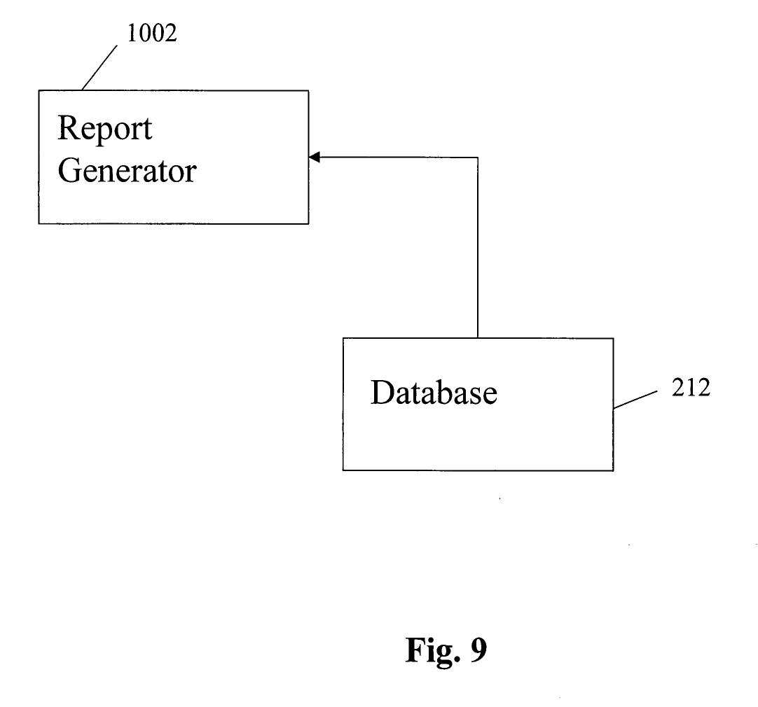

In some embodiments of the present invention, the system may also include a report generator 1002 as shown in FIG. 9. The report generator may be coupled to the database 212 in order to generate reports for a user upon request. These reports may take many forms and most generally describe the history of a document in the computer system. However, other types of displays are also available. For instance, a display could list every computer in the network that has a copy of a particular document or every interaction that a particular document or every interaction that a particular document has had with a particular user or all users in the system. Indeed, just about any type of display is possible due to the fact that in some embodiments of the present invention every interaction with every document in the computer network may be recorded, thus allowing all information related to the document to be displayed in any manner desired.

The invention may be embodied in other specific forms without departing from the scope or spirit of essential characteristics thereof. The foregoing embodiments are therefore to be considered in all respects illustrative rather than limiting on the invention described herein. The scope of the invention is thus indicated by the appended claims rather than by the foregoing description, and all changes that come within the meaning and range of equivalency of the claims are intended to be embraced therein.

1. A method of cataloging substantially all interactions with substantially all versions of a document on a computer network comprising:
determining that the document has entered the network;
creating a history for the document, the history comprising references to each copy of the document on the network and each version of the document on the network; and
updating the history each time a copy of the document or a version of the document is interacted with.

2. The method of claim 1, further comprising:
analyzing an interaction with the document to determine if an alert should be generated.

3. The method of claim 1, further comprising:
analyzing an interaction with the document to determine if an alert should be generated.

4. The method of claim 1, further comprising:
disallowing an interaction with the document if the interaction is not permissible.

5. The method of claim 1, further comprising:
determining the document is same as a preexisting document residing in the computer network.

6. The method of claim 4, further comprising:
utilizing a hash function to determine if the document is the same as the preexisting document.

7. The method of claim 1, further comprising:
storing the history in a database.

8. A method of tracking documents on a computer network comprising:
receiving an indication that either a copy of a document or a version of the document has been accessed;
determining if a history for the document exists; and
updating the history assigned to the document.

9. The method of claim 8, further comprising:
analyzing an interaction with the document to determine if an alert should be generated.

10. The method of claim 8, further comprising:
analyzing an interaction with the document to determine if an alert should be generated.

11. The method of claim 8, further comprising:
disallowing an interaction with the document if the interaction is not permissible.

12. The method of claim 8, further comprising:
determining the document is same as a preexisting document residing in the computer network.

13. The method of claim 11, further comprising:
utilizing a hash function to determine if the document is the same as the preexisting document.

14. The method of claim 8, further comprising:
storing the history in a database.

15. A system for tracking documents on a computer network comprising:
a pre-processing module that receives a signal indicating that a document in the computer network has been accessed by a user;
a processing engine that analyzes the signal to determine if the document is the same as a pre-existing document having a history associated therewith; and
a notification engine that causes the user of the document to be notified if the document being accessed has pre-defined characteristics.
